(19) United States
(12) Patent Application Publication
(10) Pub. No.: US 2026/0332256 A1
(43) Pub. Date: Oct. 22, 2026

(54) OPTICAL CHANNEL MONITORING

(71) Applicant: Ciena Corporation, Hanover, MD (US)

(72) Inventors: Antoine Bois, Quebec (CA); Francois Pelletier, Quebec (CA)

(73) Assignee: Ciena Corporation, Hanover, MD (US)

(21) Appl. No.: 19/185,670

(22) Filed: Apr. 22, 2025

(51) Int. Cl. H04B 10/079

(52) U.S. Cl. CPC H04B 10/07955

(57) ABSTRACT

A method for optical channel monitoring comprises splitting a dual-polarization optical signal received from a selected optical port into a pair of single-polarization optical signals, attenuating respective optical powers of the pair of single-polarization optical signals by a respective pair of variable attenuation amounts, thereby resulting in a pair of attenuated optical signals, propagating the pair of attenuated optical signals through a respective pair of parallel paths, thereby resulting in a respective pair of filtered optical signals, each path comprising multiple optical ring resonators in series, and wherein each of the optical ring resonators has (i) a setpoint selected for alignment with a target wavelength, and (ii) a different free spectral range (FSR) from other FSRs of the optical ring resonators, and calculating an optical power of the dual-polarization optical signal at the target wavelength using the pair of filtered optical signals and the pair of variable attenuation amounts.

### TECHNICAL FIELD

This document relates to the technical field of optical communications.

### BACKGROUND

An optical channel monitoring (OCM) device may report the optical power over a range of wavelengths or bandwidth or spectrum. Standard implementations for OCM involve microelectromechanical systems (MEMS). For example, a typical optical spectrum analyzer (OSA) may employ a rotating prism to separate light into its constituents.

### SUMMARY

According to a broad aspect, an photonic integrated circuit for optical channel monitoring comprises a first circuit configured to receive a first dual-polarization optical signal from a first optical port and to output a first pair of single-polarization optical signals, a second circuit configured to receive the first pair of single-polarization optical signals and to output a first pair of attenuated optical signals attenuated by a respective first pair of variable attenuation amounts, a third circuit configured to receive the first pair of attenuated optical signals and to output a respective first pair of filtered optical signals, the third circuit comprising a pair of parallel paths, and a fourth circuit configured to receive the first pair of filtered optical signals and to output at least one analog signal representing optical power of the first pair of filtered optical signals.

In some examples, the first circuit comprises a first optical splitter configured to produce the first pair of single-polarization optical signals.

In some examples, the first circuit is configured to receive a second dual-polarization optical signal from a second optical port, and the first circuit further comprises a second optical splitter configured to produce a second pair of single-polarization optical signals, and a first pair of on/off variable optical attenuators (VOAs) configured to selectively attenuate, based on a selected optical port, one or both of (i) the first pair of single-polarization optical signals; and (ii) the second pair of single-polarization optical signals.

In some examples, the first circuit comprises a Mach-Zehnder architecture to selectively attenuate, based on a selected optical port, one or both of (i) the first pair of single-polarization optical signals, and (ii) the second pair of single-polarization optical signals.

In some examples, the second circuit comprises a first pair of VOAs configured to attenuate respective optical powers of the first pair of single-polarization optical signals by the respective first pair of variable attenuation amounts.

In some examples, the second circuit comprises, for each single-polarization optical signal, a first tap evanescent optical coupler (EOC) configured to couple a fraction of the single-polarization optical signal into a first tap waveguide for detection by a first photodiode, and, for each attenuated optical signal, a second tap EOC configured to couple a fraction of the attenuated optical signal into a second tap waveguide for detection by a second photodiode.

In some examples, the third circuit comprises a pair of parallel paths, each path comprising N optical ring resonators in series, wherein N>1, and wherein each of the N of optical ring resonators has (i) a setpoint selected for alignment with a target wavelength, and (ii) a different free spectral range (FSR) from other FSRs of the N of optical ring resonators in the path.

In some examples, the number N of optical ring resonators satisfies 2≤N<6. For example, N=3.

In some examples, the fourth circuit comprises a dual-entry photodiode configured to detect the first pair of filtered optical signals.

In some examples, the PIC comprises a fifth circuit configured to receive a reference optical signal from a reference optical port and to output a reference pair of single-polarization optical signals, and a coupling circuit configured to couple the reference pair of single-polarization optical signals into the second circuit, where the reference optical signal is generated by a reference light emitting diode (LED) or a reference LASER.

In some examples, the PIC comprises an additional first circuit configured to receive a third dual-polarization optical signal from a third optical port and to output a third pair of single-polarization optical signals, an additional second circuit configured to receive the third pair of single-polarization optical signals and to output a third pair of attenuated optical signals attenuated by a respective second pair of variable attenuation amounts, an additional third circuit comprising an additional pair of parallel paths configured to receive the third pair of attenuated optical signals and to output a respective third pair of filtered optical signals, each path comprising M additional optical ring resonators in series, wherein M>1, and wherein each of the M of optical ring resonators has (i) a setpoint selected for alignment with the target wavelength, and (ii) a different FSR from other FSRs of the M of optical ring resonators in the path, and an additional fourth circuit configured to receive the third pair of filtered optical signals and the second pair of variable attenuation amounts, and to calculate an optical power of the third dual-polarization optical signal.

According to another broad aspect, a method for optical channel monitoring comprises splitting a dual-polarization optical signal received from a selected optical port into a pair of single-polarization optical signals, attenuating respective optical powers of the pair of single-polarization optical signals by a respective pair of variable attenuation amounts, thereby resulting in a pair of attenuated optical signals, propagating the pair of attenuated optical signals through a respective pair of parallel paths, thereby resulting in a respective pair of filtered optical signals, each path comprising N optical ring resonators in series, wherein N>1, and wherein each of the N of optical ring resonators has (i) a setpoint selected for alignment with a target wavelength, and (ii) a different FSR from other FSRs of the N of optical ring resonators, and calculating an optical power of the dual-polarization optical signal at the target wavelength using the pair of filtered optical signals and the pair of variable attenuation amounts.

In some examples, the method comprises selecting the optical port for measurement from a plurality of optical ports.

In some examples, the method comprises selecting a new value for the target wavelength, and repeating the splitting, the attenuating, the propagating, and the calculating.

In some examples, the method comprises reporting a total optical power of the dual-polarization optical signal over a spectrum.

In some examples, the attenuating is performed by a pair of VOAs, and the method comprises acquiring, at a first pair of tap EOCs, pre-VOA measurements of the optical powers of the pair of single-polarization optical signals, acquiring, at a second pair of tap EOCs, post-VOA measurements of optical powers of the pair of attenuated optical signals, and calculating the variable attenuation amounts using the pre-VOA measurements and the post-VOA measurements.

According to another broad aspect, a method for calibrating an optical channel monitoring device comprises splitting an optical signal received from a reference light source into a pair of single-polarization optical signals, propagating the pair of single-polarization optical signals through a respective pair of parallel paths, thereby resulting in a respective pair of filtered optical signals, each path comprising N optical ring resonators in series, wherein N>1, and wherein each of the N optical ring resonators has (i) a setpoint selected for alignment with a target wavelength, and (ii) a different free spectral range (FSR) from other FSRs of the N optical ring resonators in the path, aligning resonances of the N optical ring resonators on the pair of single-polarization optical signals using power maximization, and updating the setpoints of the N optical ring resonators based on the aligning.

In some examples, the method comprises coupling the single-polarization optical signals into the parallel paths using a pair of EOCs.

In some examples, the method comprises attenuating the pair of single-polarization optical signals after the updating.

### BRIEF DESCRIPTION OF THE DRAWINGS

FIG. 1 illustrates an example optical ring resonator according to PRIOR ART;

FIG. 2 is a block diagram illustration of an example architecture for optical channel monitoring (OCM) using a photonic integrated circuit (PIC);

FIG. 3 illustrates a physical layout of an example circuit configured for OCM;

FIG. 4 illustrates a first circuit in accordance with some examples of the proposed technology;

FIG. 5 illustrates a second circuit in accordance with some examples of the proposed technology;

FIG. 6 illustrates a third circuit in accordance with some examples of the proposed technology;

FIG. 7 illustrates a fourth circuit in accordance with some examples of the proposed technology;

FIG. 8-1 illustrates a fifth circuit in accordance with some examples of the proposed technology;

FIG. 8-2 illustrates an alternate fifth circuit in accordance with examples of the proposed technology;

FIG. 9 illustrates a coupling circuit in accordance with some examples of the proposed technology;

FIG. 10 illustrates a method for OCM in accordance with some examples of the proposed technology; and

FIG. 11 illustrates a method for calibrating a circuit configured for OCM in accordance with some examples of the proposed technology.

### DETAILED DESCRIPTION

Standard implementations for optical channel monitoring (OCM), such as an optical spectrum analyzer (OSA), may be limited in the resolution they can achieve. Due to the limited achievable resolution, those standard implements may be incapable of the fine tuning needed for certain applications, such as automated fiber characterization. Higher resolutions may be achievable, but at a greater complexity and higher cost. Standard OCM devices may also by limited by tuning speed. For these and other reasons, there may be interest in an OCM solution implemented using a photonic integrated circuit (PIC).

A PIC may be fabricated on a silicon photonic platform. Optical signals may be guided within the PIC by waveguides that comprise a waveguide core structure composed of a core material having an index of refraction that is higher than an index of refraction of the materials surrounding the core. One waveguide structure that has proven particularly important in the field of silicon photonics is the optical ring resonator, which is described, for example, by Bogaerts et al. in “Silicon microring resonators”, Laser Photonics Rev. 6, No. 1, 47-73, 2012.

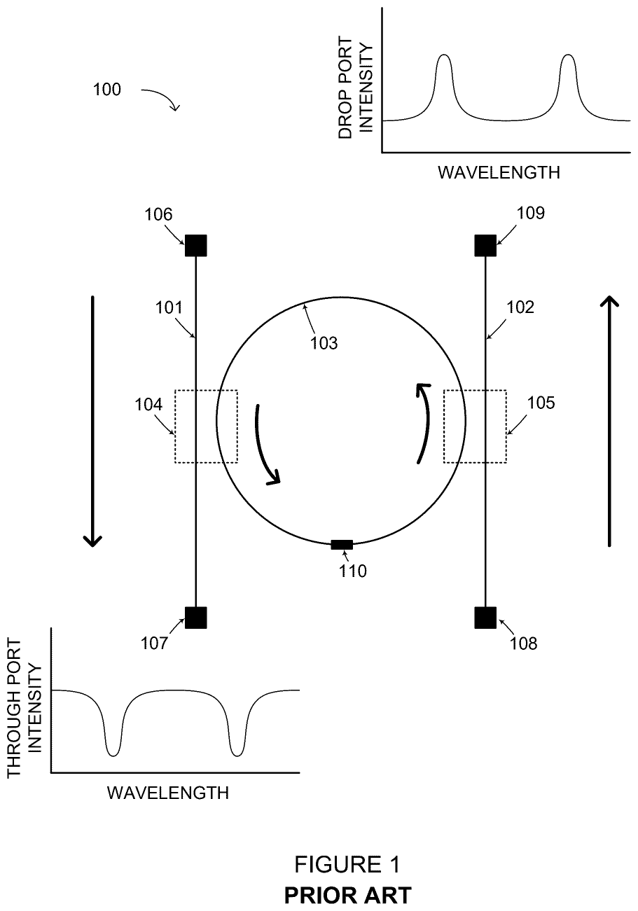

FIG. 1 illustrates an example optical ring resonator 100 according to prior art. The arrows in FIG. 1 denote the direction of light propagation within the optical ring resonator 100. This particular optical ring resonator 100 may be referred to as an add-drop ring resonator.

The optical ring resonator 100 comprises a first bus waveguide 101, a second bus waveguide 102, and a closed loop (or ring) waveguide 103. In this example, the bus waveguides 101, 102 are substantially linear within respective regions 104, 105 that are physically proximal to the ring waveguide 103, although it should be understood that they need not be linear. The first bus waveguide 101 has an input port 106 at one end and a through port 107 at the opposite end, where light propagates from the input port 106 in the direction of the through port 107. Between the input port 106 and the through port 107, the first bus waveguide 101 is in physical proximity to the ring waveguide 103 within a coupling region 104. Sufficient physical proximity between the waveguides permits light to couple between the first bus waveguide 101 and the ring waveguide 103 through field evanescence. The second bus waveguide 102 has an add port 108 at one end and a drop port 109 at the opposite end, where light is transported from the add port 108 in the direction of the drop port 109. Between the add port 108 and the drop port 109, the second bus waveguide 102 is in physical proximity to the ring waveguide 103 within a coupling region 105. This physical proximity permits light to couple between the ring waveguide 103 and the second bus waveguide 102 through evanescence. For simplicity, the coupling regions 104, 105 may be referred to herein as evanescent optical couplers (EOCs) 104, 105.

Light that propagates within a closed loop, such as the ring waveguide 103, experiences constructive and destructive interference, which results in intensity peaks and troughs. This phenomenon causes the ring waveguide 103 to function as an interferometer characterized by certain resonance wavelengths (coinciding with the intensity peaks), effectively enabling the ring waveguide 103 to act as a filter. The resonance wavelengths are based on the round-trip phase of the ring waveguide 103, and are separated by a distance known as the free spectral range (FSR), which is inversely proportional to the round-trip length of the ring waveguide 103. The FSR and the spectral widths of the peaks may be selected during design of the ring waveguide 103.

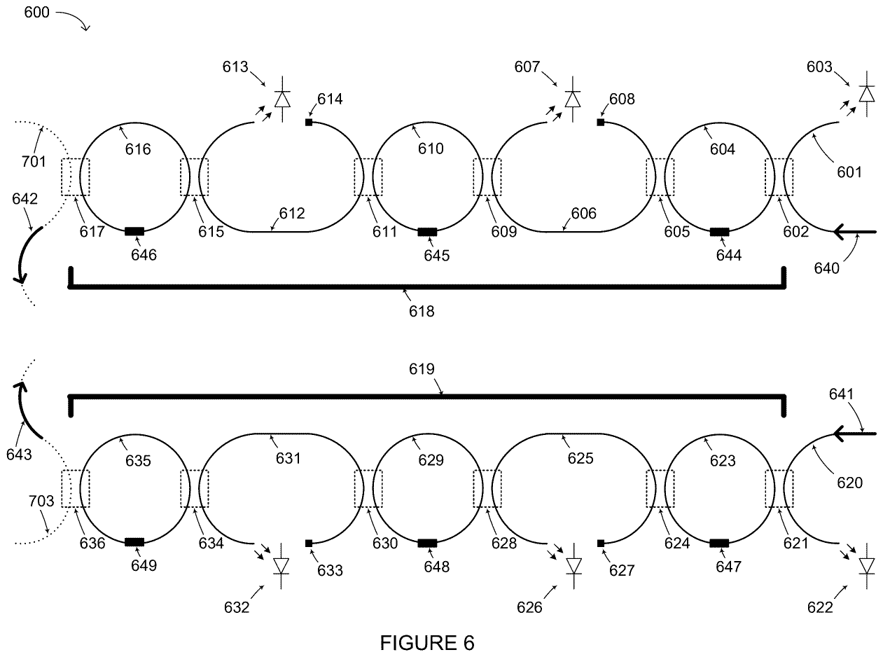

The intensity of light at the through port 107 of the first bus waveguide 101 may be measured, for example, using a photodiode (not shown). Additionally or alternatively, the intensity of light at the drop port 109 of the second bus waveguide 102 may be measured, for example, using a photodiode (not shown). As an example, one may consider light propagating on the first bus waveguide 101, towards the through port 107, the light having been generated by an input light source (not shown) optically coupled to the input port 106. A portion of the light propagating on the first bus waveguide 101 may meet the resonance requirements of the ring waveguide 103, and that portion may be coupled to the ring waveguide 103 via the first EOC 104. As a result of this coupling, the light detected at the through port 107 of the first bus waveguide 101 may contain dips or troughs in intensity at the resonant wavelengths of the ring waveguide 103. Meanwhile, the light coupled from the first bus waveguide 101 into the ring waveguide 103 is in turn coupled to the second bus waveguide 102 via the second EOC 105. The light detected at the drop port 109 of the second bus waveguide 102 may contain peaks in intensity at the resonant wavelengths of the ring waveguide 103. The resonant wavelengths may be adjustable using a tuning element 110 of the ring waveguide 103, as will be described in more detail with respect to FIG. 6.

Higher-order optical filters may be created by cascading multiple optical ring resonators in series. In one example, a series of tunable cascaded add/drop ring resonators may be used to select for a very narrow frequency band at the final drop port in the series, i.e., a bandwidth on the order of 10 GHz or less. By configuring the optical ring resonators in the series to have setpoints for the same target wavelength, and slightly different FSRs, it may be possible to select a single resonant peak while suppressing adjacent resonant peaks. This suppression of all but one resonant peak may be referred to as the Vernier method, and is described, for example, by Boeck et al. in “Series-coupled silicon racetrack resonators and the Vernier effect: theory and measurement”, Optics Express, Vol. 18, Issue 24, pp. 25151-25157, 2010. The spectral range of the Vernier effect may depend on the least common multiple of all FSRs in the series. In practice, the spectral width of each peak may be selected to minimize partial overlap of the peaks, since this overlap may create an undesirable side lobe. In general, a narrower peak may imply higher insertion loss and higher sensitivity to nonlinear effects. The number of ring resonators in the series, the FSR values of those rings, and the spectral widths of their peaks may be chosen to balance insertion losses, tuning time, power reporting accuracy, detection sensitivity, and other specifications. For example, selection of the different parameters may be done using manual optimization of the transfer function.

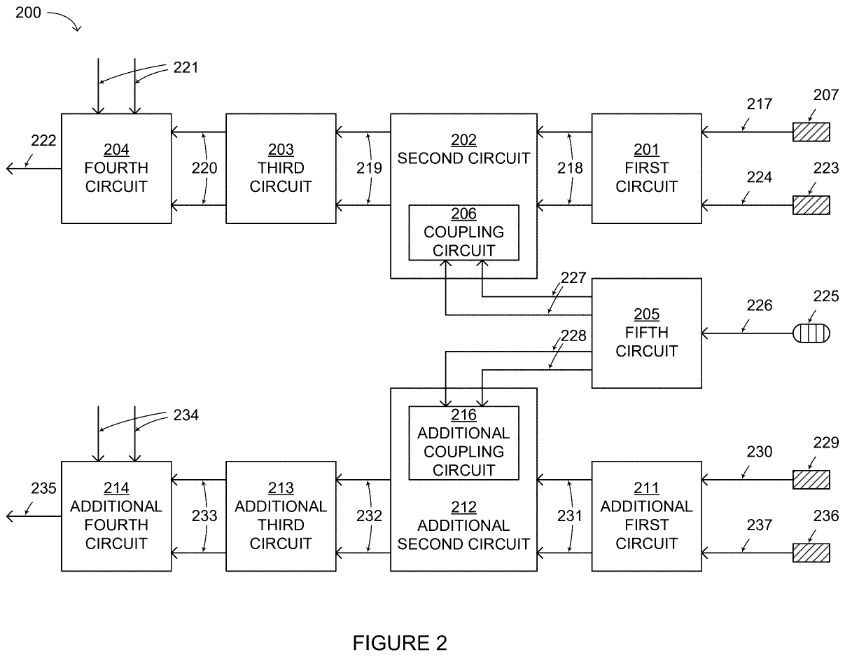

Arrows used throughout FIGS. 2-9 may be understood as representing optical signals or electrical signals, depending on context. Although not explicitly shown, optical signals may be transmitted via optical waveguides, whereas electrical signals may be transmitted via electrical connections.

The concept of an EOC has already been introduced with respect to optical ring resonators. However, EOCs may have other uses in silicon photonics besides ring resonators. In general an EOC may be configured to couple optical signals between waveguides. In some examples, an EOC may be configured as a tap coupler with a tap ratio equal to the fraction of light (e.g., 10%) that is evanescently coupled from a main waveguide to a tap waveguide (e.g., to monitor light from the main waveguide by coupling a fraction of its light into the tap waveguide that is further optically coupled to a photodiode). In some uses of EOCs, it may be helpful to determine the fraction of the light that is coupled between the first waveguide and the second waveguide (e.g., in the case of a tap coupler, so as to be able to determine the amount of light in the main waveguide).

FIG. 2 is a block diagram illustration of an example architecture 200 for OCM using a PIC.

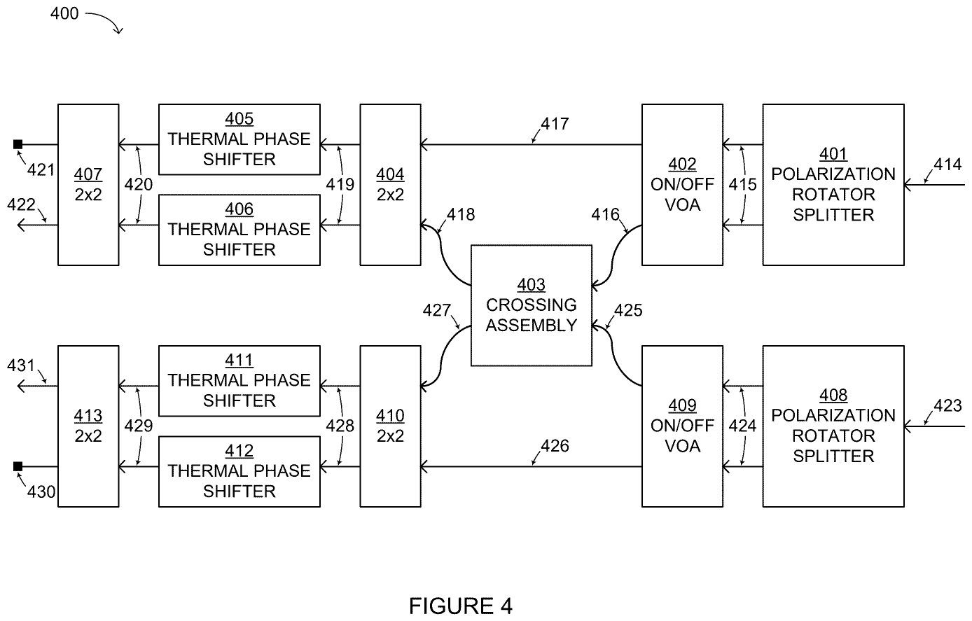

The architecture 200 may be designed to separately process single-polarization components of one or more dual-polarization signals. This separation of single-polarization components may be used because conventional active photonic integrated platforms are sensitive to polarization. To this end, the architecture 200 may comprise a first circuit 201 configured to receive a first dual-polarization optical signal 217 from a first optical port 207 and to output a first pair of single-polarization optical signals 218. The first circuit 201 may comprise a first optical splitter (not shown) configured to split the first dual-polarization optical signal 217 into two single-polarization optical signals. According to some examples, the two single-polarization optical signals may have orthogonal polarizations. For example, one signal may have a transverse electric (TE) mode, and the other signal may have a transverse magnetic (TM) mode. According to other examples, the two single-polarization optical signals may have parallel polarizations and be spatially separated. For example, both signals may have TE modes. One of the TE mode signals may be representative of a TM signal that was converted to TE mode by the first circuit 201. According to some examples, the first circuit 201 may further be configured to receive a second dual-polarization optical signal 224 from a second optical port 223, and the first circuit 201 may further comprise a second optical splitter (not shown) configured to split the second dual-polarization optical signal 224 into two components. The first circuit 201 may further comprise optical components configured to selectively attenuate the components of at least one of the first dual-polarization optical signal 217 and the second dual-polarization optical signal 224. The first circuit 201, which may be referred to as a selection circuit or a selection assembly, will be described in more detail with respect to FIG. 4.

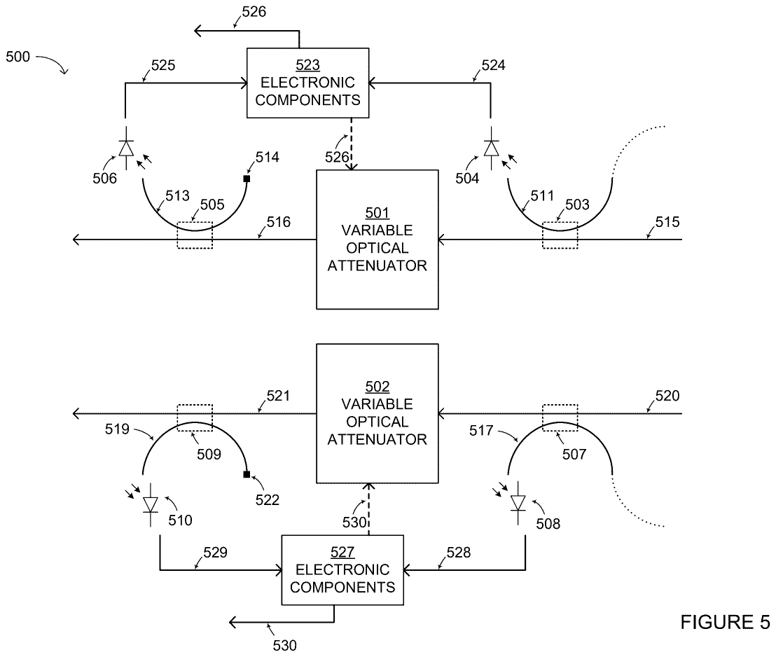

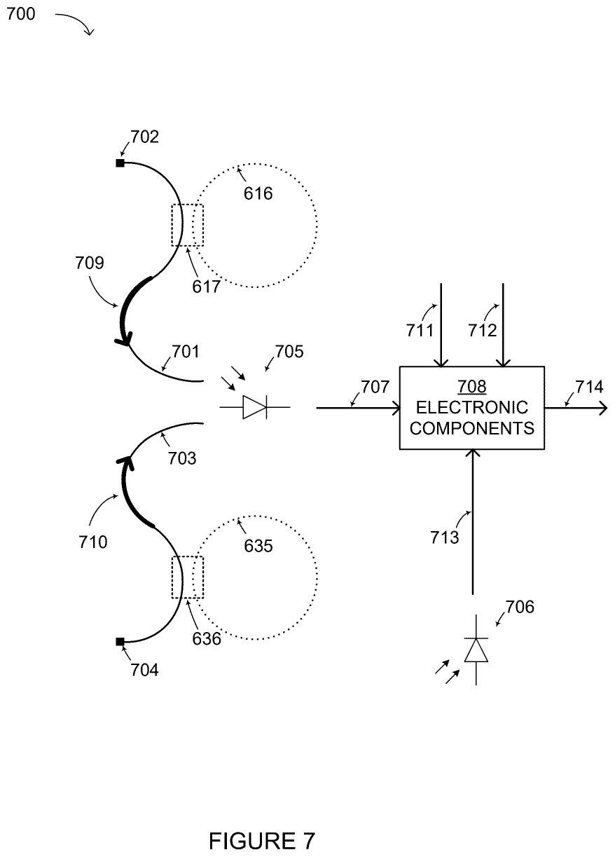

As will be explained in further detail with respect to FIG. 6, the architecture 200 may employ a series of optical ring resonators to filter the two single-polarization components of any dual-polarization optical signal received from a selected optical port. Since optical ring resonators exhibit nonlinearities at higher optical powers, it may be advantageous to limit the optical power of the signals entering the optical ring resonators. To this end, the architecture 200 may comprise a second circuit 202 that precedes the optical ring resonators, where the second circuit 202 is configured to receive the first pair of single-polarization optical signals 218 and to output a first pair of attenuated optical signals 219 attenuated by a respective first pair of attenuation amounts 221, which may be varied or adjusted, as will be described in more detail herein. (The attenuation amounts 221 may be used by other parts of the architecture 200 for OCM calculations, as will be described in more detail with respect to FIG. 7.) According to some examples, the attenuation may be achieved by a first pair of variable optical attenuators (VOAs) (not shown), and the variable attenuations amounts 221 may be determined from tap EOCs (not shown) placed before and after the VOAs. A VOA may be implemented, for example, using an electro-absorption modulator (EAM), using a MZ interferometer structure with a phase shifter in at least one arm, or using carrier injection (p-i-n junction) as described, for example, by Zheng et al. in “Improved efficiency Si-photonic attenuator”, Optics Express, Vol. 16, Issue 21, pp. 16754-16765, 2008. The second circuit 202, which may be referred to as an attenuation circuit or an attenuation assembly, will be described in more detail with respect to FIG. 5.

The architecture 200 may comprise a third circuit 203 configured to receive the first pair of attenuated optical signals 219 and to output a respective first pair of filtered optical signals 220. As will be described in more detail with respect to FIG. 6, the third circuit 203 may comprise a pair of parallel paths, each path comprising N optical ring resonators in series, where N is an integer greater than 1. The optical ring resonators in each path may be tuned such that they are aligned to a specific resonance frequency, while employing the Vernier method to suppress adjacent resonant peaks. In other words, each of the N of optical ring resonators in a given path may have (i) a setpoint selected for alignment with a target wavelength, and (ii) a different FSR from other FSRs of the N of optical ring resonators in that path. The third circuit 203 may be referred to as a filtration circuit or a filtration assembly.

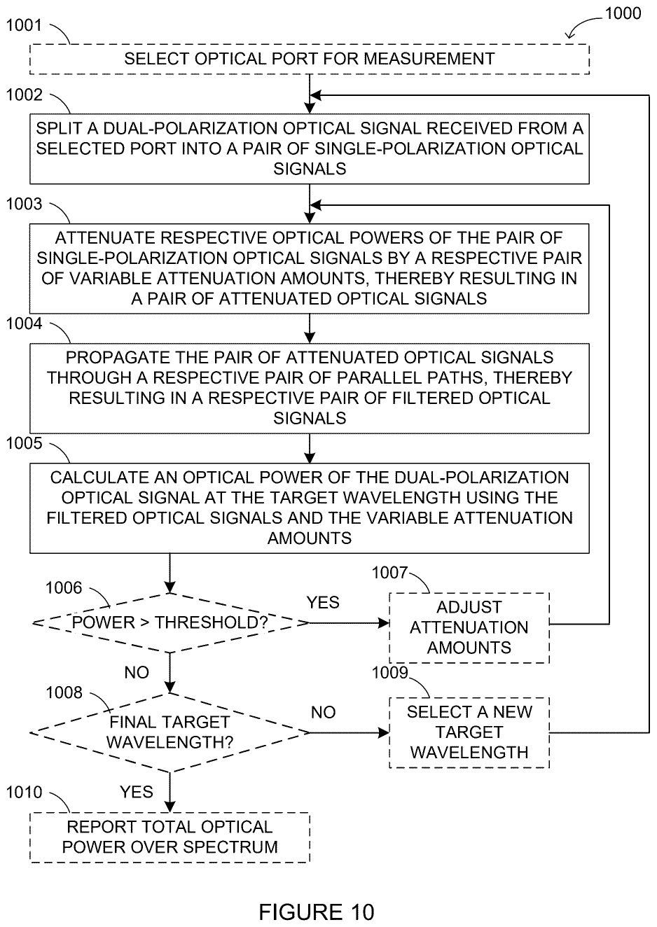

The architecture 200 may comprise a fourth circuit 204, which will be described in more detail with respect to FIG. 7. The fourth circuit 204 is configured to receive the first pair of filtered optical signals 220 and the first pair of variable attenuation amounts 221, and to calculate an optical power 222, at the target wavelength, of a dual-polarization optical signal received from a selected optical port (such as the signal 217 received from the optical port 207). By acquiring repeated measurements of the optical power 222 at a plurality of different target wavelengths, it possible to obtain an optical spectrum (intensity vs. wavelength) of the dual-polarization optical signal received from the selected port. An example method for OCM is described with respect to FIG. 10. The fourth circuit 204 may be referred to as a measurement circuit or a measurement assembly.

The first circuit 201 enables selective switching between the first optical port 207 and the second optical port 223. In this manner, the first circuit 201, the second circuit 202, the third circuit 203, and the fourth circuit 204 are effectively time-shared between the two optical ports 207, 223. Although not explicitly illustrated, it is contemplated that the first circuit 202 may be configured to switch between more than two optical ports, such that the circuits 201, 202, 203, and 204 may be time-shared between three or more optical ports. Alternatively, it is contemplated that the first circuit 201 may be dedicated to only one optical port, with no switching (and therefore no time sharing).

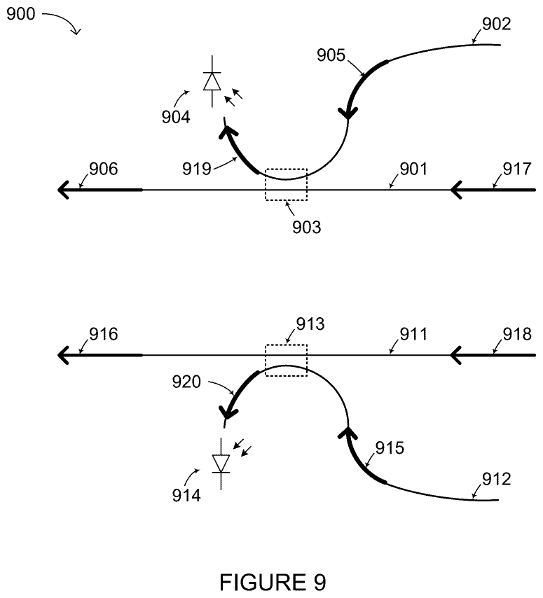

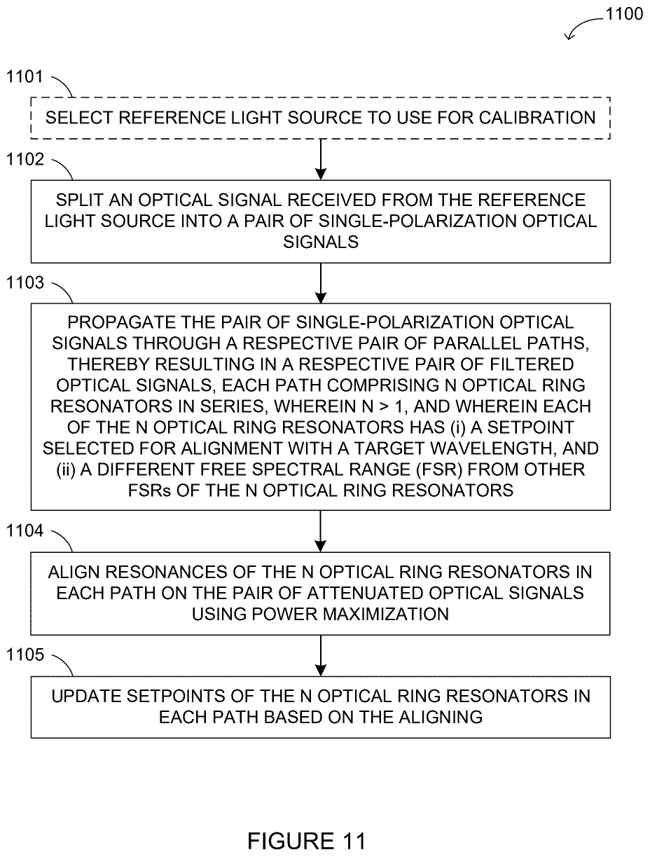

From time to time, it may be of interest to calibrate or recalibrate a PIC configured to implement OCM using the architecture 200, for example, at beginning-of-life, as well as periodically or intermittently. To this end, the architecture 200 may comprise a fifth circuit 205 configured to receive a reference optical signal 226 from a reference light source 225, such as a LASER or light-emitting diode (LED). The reference optical signal 226 may be a single-polarization optical signal or a dual-polarization optical signal. The fifth circuit 205 may comprise one or more optical splitters (not shown) configured to split the reference optical signal 226 into multiple components. The fifth circuit 205 may further comprise optical components configured to selectively attenuate the components of the reference optical signal 226. The selective attenuation may be based on selection of an optical port for measurement or a light source for calibration. For example, in the event that the reference light source 225 is selected for calibration, the fifth circuit 205 may be configured to output at least a first reference pair of single-polarization optical signals 227. In the event that the reference optical signal 226 is a dual-polarization signal, the signal pair 227 may correspond to two single-polarization components of the signal 226. The second circuit 202 may further comprise a coupling circuit 206 configured to couple the first reference pair of single-polarization optical signals 227 into the second circuit 202 so that they may be provided to the third circuit 203. The fifth circuit 205, which may be referred to as a reference circuit, will be described in more detail with respect to FIGS. 8-1 and 8-2, and the coupling circuit 206 will be described in more detail with respect to FIG. 9. An example method for calibration is described with respect to FIG. 11.

As will be described in more detail with respect to FIG. 6, the optical ring resonators may offer fast tuning speeds, such that it may be possible to sweep through a range of wavelengths in a short period of time, i.e., on the order of microseconds to nanoseconds, depending on the tuning mechanism used. However, in the event that there are multiple optical ports of interest for OCM, time-sharing of the circuits 202, 203, and 204 between optical ports may impose limitations on overall scan times. Thus, depending on required specifications, it is contemplated that the architecture 200 may comprise one or more duplicate versions of the first circuit 201, the second circuit 202, the third circuit 203, the fourth circuit 204 configured to receive and process one or more additional dual-polarization optical signals from one or more respective additional optical ports. The architecture 200 may further comprise one or more duplicate versions of the coupling circuit 206. For example, the architecture 200 may comprise an additional first circuit 211 configured to receive a third dual-polarization optical signal 230 from a third optical port 229 and to output a second pair of single-polarization optical signals 231. The additional first circuit 211 may comprise a third optical splitter (not shown) configured to split the third dual-polarization optical signal 230 into two components. According to some examples, the additional first circuit 211 may further be configured to receive a fourth dual-polarization optical signal 237 from a fourth optical port 136, and the additional first circuit 211 may further comprise a fourth optical splitter (not shown) configured to split the fourth dual-polarization optical signal 237 into two components. The additional first circuit 211 may further comprise optical components configured to selectively attenuate the two components of at least one of the third dual-polarization optical signal 230 and the fourth dual-polarization optical signal 237. The selective attenuation may be based on selection of an optical port for measurement or a light source for calibration, as described previously.

The architecture 200 may comprise an additional second circuit 212 configured to receive the second pair of single-polarization optical signals 231 and to output a second pair of attenuated optical signals 232 attenuated by a respective second pair of variable attenuation amounts 234. According to some examples, the attenuation may be achieved by a second pair of VOAs (not shown), and the attenuations amounts 234 may be determined from tap EOCs (not shown) placed before and after the VOAs of the additional second circuit 212. The additional second circuit 212 may further comprise an additional coupling circuit 216 configured to couple a second reference pair of single-polarization optical signals 228 into the additional second circuit 212 so that they may be attenuated by the VOAs (not shown), such that the reference optical signal 226 may be used for calibration.

The architecture 200 may comprise an additional third circuit 213 configured to receive the second pair of attenuated optical signals 232 and to output a respective second pair of filtered optical signals 233. Similarly to the third circuit 203, the additional third circuit 213 may comprise a pair of parallel paths, each path comprising N optical ring resonators in series, where N>1. The optical ring resonators in each path may be tuned such that they are aligned to a specific resonance frequency, while employing the Vernier method to suppress adjacent resonant peaks.

The architecture 200 may comprise an additional fourth circuit 214 configured to receive the second pair of filtered optical signals 233 and the second pair of variable attenuation amounts 234, and to calculate an optical power 235, at the target wavelength, of a dual-polarization optical signal received from a selected optical port.

Advantageously, the additional circuits 211-214 may allow for measurements to be performed on signals received from multiple optical ports at the same time. For example, the third dual-polarization optical signal 230 (or the fourth dual-polarization optical signal 237) may be measured via the additional circuits 211-214 simultaneously or concurrently to measuring the first dual-polarization optical signal 217 (or the second dual-polarization optical signal 224) via the circuits 201-204. Additional sets of duplicate circuits may enable more optical ports to be scanned simultaneously or concurrently, with the gain in speed being balanced against the size, cost, and complexity of the architecture.

Attenuation of the pair of single-polarization optical signals 218 (and/or 231) ensures that the attenuated signals 219 (and/or 232) being received by the series of optical ring resonators in the third circuit 203 (and/or the additional third circuit 213) are limited in power. As previously noted, this may be advantageous because ring resonators are known to exhibit nonlinearities at higher optical powers. By using a configuration that limits the power entering the ring resonators, it may be possible to achieve OCM over a higher dynamic range, for example, on the order of 40 to 60 dB.

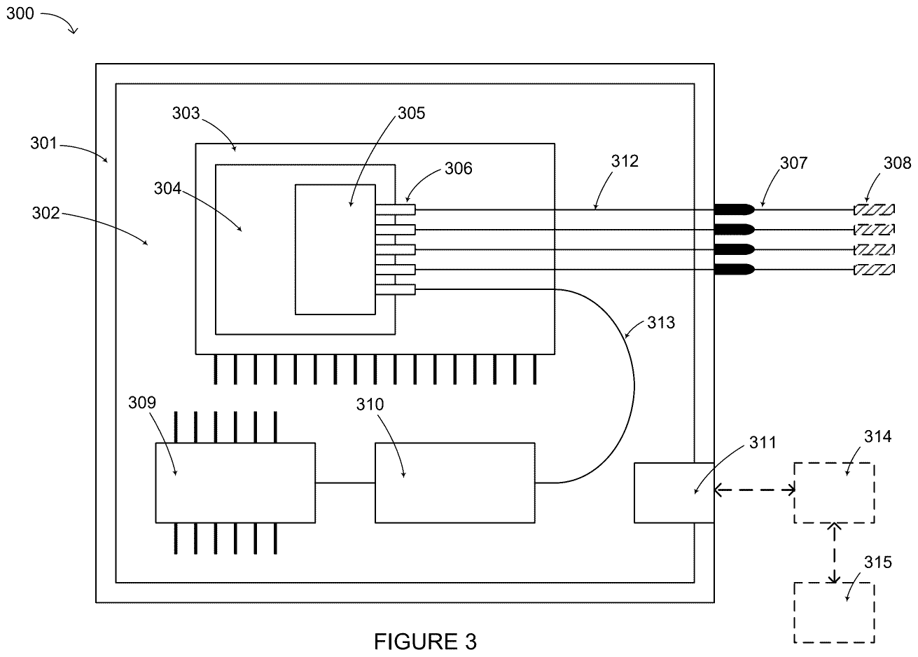

FIG. 3 illustrates a physical layout of an example circuit 300 for OCM.

The circuit 300 comprises a printed circuit board (PCB) 302 within an external casing 301. Connected to the PCB 302 is a standalone package 303 comprising a PIC 305 mounted on a thermoelectric cooler (TEC) 304. The PIC 305 may comprise optical components configured for OCM according to the architecture 200. The standalone package 303 further comprises a fiber array or multiple fiber ferrules 306, one or more of which are configured for connection with a connectorized fiber output 307 of the circuit 300 via one or more respective waveguides 312. In turn, the connectorized fiber output 307 is configured for connection with one or more respective optical ports 308. According to some examples, the optical ports 308 may correspond to the optical ports 207, 223, 229, 236 as described with respect to FIG. 2.

The circuit 300 further comprises a reference light source 309, such as a LASER or LED, which is configured to provide an external wavelength reference to the PIC 305 via a waveguide 313 which is connected to one of the fiber ferrules 306. According to some examples, the reference light source 309 may correspond to the reference light source 225 as described with respect to FIG. 2. The circuit 300 may further comprise an external shaper 310 configured to shape light emitted from the reference light source 309, and the shaped light may be provided to the PIC 305 via the waveguide 313. Shaping may be done, for example, according to the methods described in United States Patent Application Publication No. 20230314310 to Ciena Corporation.

The circuit 300 further comprises an electronic communication interface 311, such as a serial peripheral interface (SPI), configured for electrical connection and communication with other components external to the circuit 300. For example, the interface 311 may enable communication between various components of the circuit 300 and a controller 314, where the controller 314 may be configured to control functionality of the circuit 300 based on computer-executable instructions stored in a computer-readable medium 315. The PIC 300, the controller 314, and the computer-readable medium 315 may be comprised within an optoelectronic device configured to perform OCM (i.e., an OCM device).

FIG. 4 illustrates a first circuit 400 in accordance with some examples of the proposed technology. The first circuit 400 is an example of the first circuit 201 or the additional first circuit 211. As will be described in more detail below, the first circuit 400 may act as a channel isolation switch that enables switching between different optical ports while providing polarization splitting.

The first circuit 400 comprises a first polarization rotator splitter 401 configured to split a first dual-polarization optical signal 414 into two single-polarization components 415. In parallel to the first polarization rotator splitter 401, the first circuit 400 comprises a second polarization rotator splitter 408 configured to split a second dual-polarization optical signal 423 into two single-polarization components 424. The dual-polarization optical signals 414, 423 may be received from two different optical ports. For example, the dual-polarization optical signals 414, 423 may correspond, respectively, to the signals 217, 224 or the signals 230, 237 described with respect to FIG. 2.

The first circuit 400 further comprises a first pair of on/off VOAs 402, 409 jointly configured to selectively attenuate one or both of (i) the single-polarization components 415 of the first dual-polarization optical signal 414; and (ii) the single-polarization components 424 of the second dual-polarization optical signal 423. The selective attenuation may be based on selection of an optical port for measurement or a light source calibration. For example, when selecting for measurement the optical port that provides the signal 414, the on/off VOA 402 may be set to “off”, so as to achieve substantially zero attenuation of the single-polarization components 415, while the on/off VOA 409 may be set to “on”, so as to achieve substantially 100% attenuation of the single-polarization components 424. In other words, the components 415 of the signal 414 are passed, while the components 424 of the signal 423 are blocked. In another example, when selecting for measurement another optical port (other than the ports providing the signals 414, 423) or when selecting a reference light source for calibration (such as the reference light source 225 or 309), both of the on/off VOAs 402, 409 in the first circuit 400 may be set to “on”, such that there is substantially 100% attenuation of the components 415 and the components 424, thereby effectively blocking both sets of components.

The on/off VOA 402 outputs optical signals 416, 417, while the on/off VOA 409 outputs optical signals 425, 426. The signals 416, 425 are provided to a crossing assembly 403 which outputs respective signals 427, 418, where the signal 427 corresponds to the signal 416 and the signal 418 corresponds to the signal 425. The crossing assembly 403 may be configured to minimize losses and crosstalk, for example, as described by Liu et al. in “Low-loss waveguide crossing using a multimode interference structure”, Optics Communications 241.1-3, 99-104, 2004.

The first circuit 400 comprises a Mach-Zehnder (MZ) architecture, which is substantially wavelength-independent, to effectively steer light from four waveguides to two waveguides, as will be described in more detail below. The MZ architecture comprises multiple 2×2 components, examples of which include directional couplers, y-branches, adiabatic couplers, and multimode interferometers (MMIs) such as those described by Soldano et al. in “Optical multi-mode interference devices based on self-imaging: principles and applications”, Journal of Lightwave Technology, Vol. 13, Issue 4, pages 615-627, 1995.

The signals 417, 418 are provided to a first 2×2 component 404, while the signals 426, 427 are provided to a second 2×2 component 410. The first 2×2 component 404 outputs a pair of signals 419 which are processed by a respective pair of thermal phase shifters 405, 406, thereby resulting in a respective pair of signals 420. The pair of signals 420 are provided to a third 2×2 component 407, which outputs a first single-polarization optical signal 422, as well as a signal destined for a drop port (or optical sink) 421. The thermal phase shifters 405, 406 are configured to act on the phase to change the condition of interference which occurs at the third 2×2 component 407. The second 2×2 component 410 outputs a pair of signals 428 which are processed by a respective pair of thermal phase shifters 411, 412, thereby resulting in a respective pair of signals 429. The pair of signals 429 are provided to a fourth 2×2 component 413, which outputs a second single-polarization optical signal 431, as well as a signal destined for a drop port 430. The thermal phase shifters 411, 412 are configured to act on the phase to change the condition of interference which occurs at the fourth 2×2 component 413. In practice, there is substantially zero light output to the drop ports 421, 430. The MZ architecture selects either the signal 417 or the signal 418 to steer to the path of the signal 422, and selects either signal 427 or signal 428 to steer to the path of the signal 431. The signals not selected by the switch are steered to the drop ports 421 and 430. The signals 422, 431 may correspond to the pair of signals 218 or the pair of signals 231 described with respective to FIG. 2.

FIG. 5 illustrates a second circuit 500 in accordance with some examples of the proposed technology. The second circuit 500 is an example of the second circuit 202 or the additional second circuit 212.

The second circuit 500 comprises a pair of VOAs 501, 502 configured to attenuate respective optical powers of a pair of single-polarization optical signals 515, 520, thereby resulting in a respective pair of attenuated optical signals 516, 521. The pair of single-polarization optical signals 515, 520 may correspond to the signal pair 218 or the signal pair 231 described with respect to FIG. 2, while the pair of attenuated optical signals 516, 521 may correspond to the signal pair 219 or the signal pair 232 described with respect to FIG. 2.

The second circuit 500 further comprises a pair of first tap EOCs 503, 507 configured to couple respective fractions of the optical signals 515, 520 into respective first tap waveguides 511, 517 for detection by a respective pair of first photodiodes 504, 508. For example, approximately 10% of the optical signal 515 may be coupled into the first tap waveguide 511 via the tap EOC 503, and the optical power of that fraction of the optical signal 515 may be measured by the first photodiode 504. Similarly, approximately 10% of optical signal 520 may be coupled into the other first tap waveguide 517 via the other first tap EOC 507, and the optical power of that fraction of the optical signal 520 may be measured by the other first photodiode 508. The first photodiodes 504, 508 may output respective electrical signals 524, 528 representing the optical powers of the signals on the respective waveguides 511, 517. Electronic components 523, 527 may be used to process the respective electrical signals 524, 528 to calculate the optical powers of the signals 515, 520 entering the VOAs 501, 502 (i.e., pre-VOA measurements).

The second circuit 500 further comprises a pair of second tap EOCs 505, 509 configured to couple respective fractions of the optical signals 516, 521 into a respective pair of second tap waveguides 513, 519 for detection by a respective pair of second photodiodes 506, 510. For example, approximately 10% of the optical signal 516 may be coupled into the second tap waveguide 513 via the tap EOC 505, and the optical power of that fraction of the optical signal 516 may be measured by the second photodiode 506. Similarly, approximately 10% of optical signal 521 may be coupled into the other second tap waveguide 519 via the other second tap EOC 509, and the optical power of that fraction of the optical signal 521 may be measured by the other second photodiode 510. The second photodiodes 506, 510 may output respective electrical signals 525, 529 representing the optical powers of the signals on the respective waveguides 513, 519. The electronic components 523, 527 may be used to process the respective electrical signals 525, 529 to calculate the optical powers of the signals 516, 521 exiting the VOAs 501, 502. (i.e., post-VOA measurements). Furthermore, the electronic components 523, 527 may be configured to calculate respective variable attenuation amounts applied by the pair of VOAs 501, 502. For example, the electronic components 523 may be configured to perform a comparison of the signal 524 and the signal 525, which may be used to calculate an attenuation amount 526 representing the variable attenuation applied by the VOA 501. Similarly, the electronic components 527 may be configured to perform a comparison between the signal 528 and the signal 529, which may be used to calculate an attenuation amount 530 representing the variable attenuation applied by the VOA 502. The attenuation amounts 526, 530, which may be represented by electrical signals, may be used during OCM calculations, as will be described further with respect to FIG. 7.

The VOAs 501, 502 may be controlled by a controller, such as the controller 314, and may be adjusted based on the calculated attenuation amounts 526, 530, as denoted by the dashed arrows. As an example, the attenuation amount 526 may be targeted to achieve a sufficiently low intensity for the signal 516 (and, by proxy, for the signal 525) over a given spectral slice being measured.

According to some examples, the second tap waveguides 513, 519 may terminate in respective drop ports 514, 522 located at the ends opposite the second photodiodes 506, 510. According to some examples, the first tap waveguides 511, 517 may be incorporated into respective coupling circuits, such as the coupling circuit 206 and the additional coupling circuit 216, as will be described further with respect to FIG. 9. In this manner, the pair of first tap EOCs 503, 507 may be used to couple a reference optical signal into the second circuit 500, which may be used for calibration.

FIG. 6 illustrates a third circuit 600 in accordance with some examples of the proposed technology. The third circuit 600 is an example of the third circuit 203 or the additional third circuit 213.

The third circuit 600 comprises a pair of parallel paths (or arms or channels) 618, 619, each path comprising N optical ring resonators in series, where N is an integer greater than 1. In this particular example, N=3, but larger or smaller values of N are contemplated. For example, the number N of optical ring resonators in a given path may satisfy 2≤N<6. The path 618 comprises three ring waveguides 604, 610, and 616, while the path 619 comprises three ring waveguides 623, 629, and 635. The ring waveguides 604, 610, 616, 623, 629, 635 have respective tuning elements 644, 645, 646, 647, 648, 659, where each tuning element may be used to adjust a setpoint of the respective ring waveguide, for example, using thermal tuning, carrier effects, or crystal electro-optic effects. Examples of tuning mechanisms are described by Chrostowski et al. in “Silicon photonics design: from devices to systems”, Cambridge University Press, 2015 and by Dong et al. in “Wavelength-tunable silicon microring modulator”, Optics Express, Vol. 18, Issue 11, pp. 10941-10946, 2010. Using the tuning elements 644, 645, 646, 647, 648, 659, the setpoints of the ring waveguides 604, 610, 616, 623, 629, 635 may be selected for alignment with a target wavelength.

Within a given path, each ring waveguide may have a different FSR from other FSRs of the ring waveguides in that path. For example, the ring waveguides 604, 610, and 616 in the path 618 may have three distinct FSRs from one another, while the ring waveguides 623, 629, and 635 in the path 619 may also have three distinct FSRs from one another. By designing the optical ring resonators in a given path to have different FSRs, while also tuning the setpoints to the same target wavelength, the series of optical ring resonators may function as a Vernier filter, such that the optical signal propagating on the final ring waveguide in the series comprises a single intensity peak centered on the target wavelength. The tuning elements may be adjusted over time to scan across a band of target wavelengths. As previously noted, optical ring resonators may achieve fast tuning speeds: for example, a time constant in the range of 1-30 microseconds for thermal phase shifters or in the range of nanoseconds when tuning is done with carrier effects

The third circuit 600 is configured to receive a pair of attenuated optical signals 640, 641, such as the signals 516, 521 output by the second circuit 500 or the signal pair 219 output by the second circuit 202 or the signal pair 232 output by the additional second circuit 212. The third circuit 600 is further configured to output a respective pair of filtered optical signals 642, 643, such as the signal pair 220 output by the third circuit 203 or the signal pair 233 output by the additional third circuit 213.

In this example, the pair of attenuated optical signals 640, 641 propagate on a respective pair of bus waveguides 601, 620. A portion of the light propagating on the non-ring waveguides 601, 620 may meet resonance requirements of the respective ring waveguides 604, 623 (i.e., the first ring waveguides in the series), and that portion may be coupled to the ring waveguides 604, 623 within respective EOCs 602, 621. The remaining portion of the light propagating on the bus waveguides 601, 620 may optionally be detected by respective photodiodes 603, 622. Alternatively, the bus waveguides 601, 620 may terminate in drop ports (not shown).

Light propagating on the first ring waveguides 604, 623 may be coupled to respective bus waveguides 606, 625 via respective EOCs 605, 624. A portion of the light propagating on the bus waveguides 606, 625 may meet resonance requirements of the respective ring waveguides 610, 629 (i.e., the second ring waveguides in the series), and that portion may be coupled to the ring waveguides 610, 629 within respective EOCs 609, 628. The remaining portion of the light propagating on the bus waveguides 606, 625 may optionally be detected by respective photodiodes 607, 626. The bus waveguides 606, 625 may comprise respective optical sinks 608, 627 opposite the ends associated with the photodiodes 607, 626. In some examples, both ends of the bus waveguides 606, 625 may terminate in drop ports.

Light propagating on the second ring waveguides 610, 629 may be coupled to respective bus waveguides 612, 631 via respective EOCs 611, 630. A portion of the light propagating on the bus waveguides 612, 613 may meet resonance requirements of the respective ring waveguides 616, 635 (i.e., the third ring waveguides in the series), and that portion may be coupled to the ring waveguides 616, 635 within respective EOCs 615, 634. The remaining portion of the light propagating on the bus waveguides 612, 631 may optionally be detected by respective photodiodes 613, 632. The bus waveguides 612, 631 may comprise respective optical sinks 614, 633 opposite the ends associated with the photodiodes 613, 632. In some examples, both ends of the bus waveguides 612, 631 may terminate in drop ports.

Light propagating on the third ring waveguides 616, 635 may be coupled to respective bus waveguides 701, 703 via respective EOCs 617, 636, where the bus waveguides 701, 703 are comprised in a fourth circuit, such as the fourth circuit 204 or the additional fourth circuit 214. In this manner, light propagating on the on the third ring waveguides 616, 635 may be provided to the fourth circuit as respective filtered optical signals 642, 643.

Advantageously, the optical signals 640, 641 received by the third circuit 600 may be power-limited by the VOAs 501, 502 of the second circuit 500, thereby avoiding or reducing nonlinear effects known to arise in ring resonators at higher optical powers.

According to some examples, the optical signals detected by the photodiodes 603, 607, 613, 622, 626, 632 may be used to adjust the attenuation applied by the VOAs 501, 502 of the second circuit 500. For example, in the event that any of the photodiodes 603, 607, 613, 622, 626, 632 detects an optical signal having a power that exceeds a certain threshold, the attenuation applied by the corresponding VOA may be increased so as to limit nonlinearity in the optical ring resonators.

FIG. 7 illustrates a fourth circuit 700 in accordance with some examples of the proposed technology. The fourth circuit 700 is an example of the fourth circuit 204 or the additional fourth circuit 214.

The fourth circuit 700 is configured to receive a pair of filtered optical signals 709, 710, such as the signal pair 220 output by the third circuit 203 or the signal pair 233 output by the additional third circuit 213 or the signals 642, 643 output by the third circuit 600. The fourth circuit 700 is also configured to receive a pair of attenuation amounts 711, 712, such as the pair 221 or the pair 234 or the pair 526, 530. When incorporated into the architecture 200, the fourth circuit 700 is configured to calculate an optical power of a dual-polarization optical signal at one or more target wavelengths.

As described with respect to FIG. 6, the fourth circuit 700 comprises the pair of bus waveguides 701, 703 which are configured to receive the respective filtered optical signals 709, 710, for example, from the third circuit 600 via the respective EOCs 617, 636. One end of each of the bus waveguides 701, 703 may terminate in a respective drop port, denoted 702, 704, respectively. The opposite end of each of the bus waveguides 701, 703 may be optically coupled to one or more photodiodes. In this example, a single dual-entry photodiode 705 is configured to receive the filtered optical signals 709, 710 propagating on the respective bus waveguides 701, 703. Example dual-entry photodiodes are described in more detail, for example, in U.S. Pat. No. 10,830,638 to Ciena Corporation. Other possibilities are contemplated. For example, instead of a dual-entry photodiode, there could be two single-entry photodiodes: one configured to receive the filtered optical signal 709 and the other configured to receive the filtered optical signal 710.

The one or more photodiodes 705 may output at least one analog electrical signal 707 representing optical power of the filtered optical signals 709, 710. The fourth circuit 700 may comprise electronic components 708 configured to receive the electrical signal 707 as well as the pair of attenuation amounts 711, 712 representing the variable attenuation applied by the VOAs in the second circuit. The electronic components 708 may be configured to use the electrical signal 707 and the attenuation amounts 711, 712 to calculate an optical power 714 of a dual-polarization optical signal, such as the signal 217, the signal 224, the signal 230, the signal 237, the signal 414, or the signal 423.

Noise reduction may be achieved by controlling stray or unguided light. To this end, the fourth circuit 700 may further comprise a reference photodiode 706 configured to output an analog signal 713 representative of detected dark current and parasitic light, and the electronic components 708 may be configured to account for the signal 713 during calculation of the optical power 714. More details may be found, for example, in U.S. Pat. No. 11,391,627 to Ciena Corporation.

It should be noted that direct monitoring of optical power inside the ring resonators of the third circuit 600 is possible. For example, a reverse biased PIN junction may collect free carriers and generate an electrical signal proportional to the optical power inside a given ring resonator. According to some examples, this electrical signal (not shown) may be provided to the electronic components for use in calculating the optical power 714.

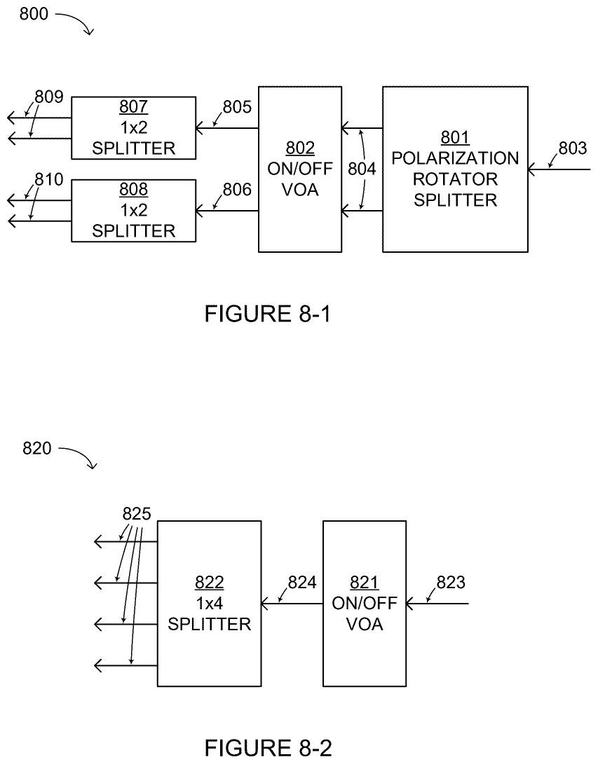

FIG. 8-1 illustrates a fifth circuit 800 in accordance with some examples of the proposed technology. The fifth circuit 800 is an example of the fifth circuit 205.

The fifth circuit 800 comprises a polarization rotator splitter 801 configured to split a reference dual-polarization optical signal 803 into single-polarization components 804. The reference dual-polarization optical signal 803 may be received from a reference light source, such as a LASER or LED. For example, the reference dual-polarization optical signal 803 may correspond to the signal 226 as described with respect to FIG. 2, or to the signal propagated on the waveguide 313 as described with respect to FIG. 3.

According to some examples, the fifth circuit 800 may further comprise an on/off VOA 802 configured to selectively attenuate the single-polarization components 804 of the reference dual-polarization optical signal 803 based on whether or not the reference light source has been selected for calibration. For example, when selecting to measure light from an optical port, such as any one of the optical ports 207, 223, 229, 236, the on/off VOA 802 may be set to “on”, so as to achieve substantially 100% attenuation of the components 804. In other words, the single-polarization signals 804 may be blocked. In another example, when selecting to use the reference light source for calibration, the on/off VOAs 802 in the fifth circuit 800 may be set to “off”, so as to achieve substantially zero attenuation of the single-polarization components 804. Under these circumstances, the on/off VOAs in any first circuits (e.g., the first circuit 201 and the additional first circuit 211) would be set to “on”, so as to achieve substantially 100% attenuation of all other optical signals while calibration is being performed.

The fifth circuit 800 may comprise a first 1×2 optical splitter 807 configured to receive a first output signal 805 from the on/off VOA 802, and to split the first output signal 805 into an optical signal pair 809 which may be used for calibration. For example, the optical signal pair 809 may correspond to the optical signal pair 227 provided to the coupling circuit 206. The fifth circuit 800 may further comprise a second 1×2 optical splitter 808 configured to receive a second output signal 806 from the on/off VOA 802, and to split the second output signal 806 into an optical signal pair 810 which may also be used for calibration. For example, the optical signal pair 810 may correspond to the optical signal pair 228 provided to the coupling circuit 216.

FIG. 8-2 illustrates a fifth circuit 820 in accordance with some examples of the proposed technology. The fifth circuit 820 is an example of the fifth circuit 205.

The fifth circuit 820 is configured to receive a reference single-polarization optical signal 823 from a reference light source, such as a LASER or LED. For example, the reference single-polarization optical signal 823 may correspond to the signal 226 as described with respect to FIG. 2, or to the signal propagated on the waveguide 313 as described with respect to FIG. 3.

The fifth circuit 820 may further comprise an on/off VOA 821 configured to selectively attenuate the single-polarization optical signal 823 based on whether or not the reference light source has been selected for calibration.

The fifth circuit 820 may comprise a 1×4 optical splitter 822 configured to receive an output signal 824 from the on/off VOA 821, and to split the output signal 824 into four identical optical signals 825 which may be used for calibration. For example, two of the four optical signals 825 may correspond to the optical signal pair 227 provided to the coupling circuit 206, while the remaining two optical signal 825 may correspond to the optical signal pair 228 provided to the coupling circuit 216.

As an alternative to using the on/off VOA 802 (or the on/off VOA 821), selective transmission of the signals 809, 810 (or 825) could be achieved by turning the reference light source on only when calibration is being performed, and leaving the reference light source off at all other times.

FIG. 9 illustrates a coupling circuit 900 in accordance with some examples of the proposed technology. The coupling circuit 900 is an example of the coupling circuit 206 or the additional coupling circuit 216.

As indicated in FIG. 2, the coupling circuit 900 may be incorporated into each respective second circuit 202, 212 of the architecture 200. Alternatively (not shown in FIG. 2), the coupling circuit 900 may be separate from each second circuit. These two options will be described in more detail below.

The coupling circuit 900 is configured to couple a reference pair of single-polarization optical signals 905, 915, into a second circuit, such as the second circuit 202 or the additional second circuit 212 or the second circuit 500. The reference signals 905, 915 may correspond, for example, to the signal pair 809 or the signal pair 810 output by the fifth circuit 800, or to a pair of the signals 825 output by the fifth circuit 820.

The optical signals 905, 915 may be received by the coupling circuit 900 via a respective pair of waveguides 902, 912. The coupling circuit 900 may comprise a pair of EOCs 903, 913 configured to couple portions of the optical signals 905, 915 from the waveguides 902, 912 into a respective pair of waveguides 901, 911. The waveguides 901, 911 may be optically connected to the respective outputs of a first circuit, such as the first circuit 201, the additional first circuit 211, or the first circuit 400. For example, waveguides 901, 911 may be configured to propagate respective signals 917, 918 corresponding to the signals 422, 431 described with respect to FIG. 4.

As previously described with respect to FIGS. 4, 8-1, and 8-2, on/off VOAs may be used to selectively attenuate the signals output by the first circuit 400 and the fifth circuit 800 (or the fifth circuit 820). In the event that a calibration operation is to be performed, the on/off VOAs 402, 409 in the first circuit 400 may both be set to “on” (full attenuation), while the on/off VOA 802 in the fifth circuit 800 (or the on/off VOA 821 of in the fifth circuit 820) may be set to “off” (no attenuation). Under these circumstances, the signals 917, 918 received at the coupling circuit 900 would be negligible relative to the reference signals 905, 915. Alternatively, in the event that a measurement operation is to be performed, the on/off VOAs 402, 409 in the first circuit 400 may both be set to “off” (no attenuation), while the on/off VOA 802 in the fifth circuit 800 (or the on/off VOA 821 of in the fifth circuit 820) may be set to “on” (full attenuation). Under these circumstances, the reference signals 905, 915 received at the coupling circuit 900 would be negligible relative to the signals 917, 918.

The optical signals propagating on the waveguides 902, 912 after the respective EOCs 903, 913 are denoted by 919, 920, respectively. The optical signals propagating on the waveguides 901, 911 after the respective EOCs 903, 913 are denoted by 906, 916, respectively. The coupling circuit 900 may comprise a respective pair of photodiodes 904, 914 configured to measure the respective optical powers of signals 919, 920.

In the event that coupling circuit 900 forms a part of the second circuit 500, the waveguides 902, 912 may correspond, for example, to the waveguides 511, 517 (or the waveguides 513, 519); the optical EOCs 903, 913 may correspond, for example, to the tap EOCs 503, 507 (or the tap EOCs 505, 509); and the photodiodes 904, 914, may correspond, for example, to the photodiodes 504, 508 (or the photodiodes 506, 510).

FIG. 10 illustrates a method 1000 for OCM in accordance with some examples of the proposed technology. The method 1000 may be performed, for example, using the architecture 200 incorporated within the circuit 300. One or more steps of the method 1000 may be triggered by a controller of the circuit 300, such as the controller 314, based on computer-readable instructions stored on a computer-readable medium, such as the memory 315.

The method may begin with an optional step 1001 of selecting an optical port for measurement. For example, where the OCM architecture comprises components that are time-shared between multiple optical ports (e.g., ports 207 and 223 in FIG. 2), a particular optical port may be selected. For example, selecting an optical port for measurement may involve toggling the on/off VOAs in the first circuit 201. Selecting an optical port for measurement may also involve setting the on/off VOA of the fifth circuit 205 to “on”, or turning off the reference light source 225.

At 1002, a dual-polarization optical signal received from a selected port is split into a pair of single-polarization optical signals. For example, the first circuit 201 may split the signal 217 (or the signal 224) into single-polarization components, and may output the signal 218.

According to some examples, the splitting may be achieved by a polarization rotator splitter such as 401 or 408.

At 1003, respective optical powers of the pair of optical signals are attenuated by a respective pair of variable attenuation amounts, thereby resulting in a pair of attenuated optical signals. For example, the second circuit 202 may attenuate the signal pair 218, thereby resulting in the attenuated signal pair 219. According to some examples, the attenuating may be achieved by a respective pair of VOAs, such as the VOAs 501, 502 described with respect to FIG. 5. The attenuation amounts may be determined using tap EOCs and photodiodes, before and after the VOAs 501, 502, as previously described.

At 1004, the pair of attenuated optical signals are propagated through a respective pair of parallel paths, thereby resulting in a respective pair of filtered optical signals. For example, as described with respect to FIG. 2, the third circuit 203 may filter the attenuated signal pair 219, thereby resulting in the filtered signal pair 220. Each path comprises N optical ring resonators in series, where N>1, and where each of the N optical ring resonators has (i) a setpoint selected for alignment with a target wavelength, and (ii) a different FSR from other FSRs of the N optical ring resonators in the path. For example, as described with respect to FIG. 6, the third circuit 600 comprises the parallel paths 618, 619, where each path comprises N=3 optical ring resonators in series.

At 1005, an optical power of the dual-polarization optical signal is calculated using the pair of filtered optical signals and the pair of attenuation amounts. For example, the fourth circuit 204 may calculate the optical power 222 using the signal pair 220 and the pair of attenuation amounts 221. Step 1005 may involve using one or more photodiodes, such as the photodiode 705, to measure the optical powers of the filtered optical signals, and adjusting those measurements to account for the attenuation applied to the single-polarization optical signals by the VOAs prior to the filtering done by the optical ring resonators.

At 1006, a determination is made as to whether the optical power calculated at 1005 is too high, such that the optical ring resonators may be exhibiting nonlinear effects. For example, the optical power calculated at 1005 may be compared to a predetermined threshold, above which nonlinear effects are anticipated. If it is determined at 1006 that the optical power exceeds the threshold, the variable attenuation amounts may be adjusted at 1007, and steps 1003-1005 may be repeated for the new attenuation amounts. Once a determination is made at 1006 that the optical power does not exceed the threshold, the method 1000 may proceed to step 1008.

At 1008, a determination is made as to whether the final target wavelength in a chosen bandwidth for measurement has been reached. If the current target wavelength is not the final target wavelength, a new target wavelength is selected at 1009, and steps 1002-1007 are repeated for the new target wavelength. For each target wavelength that is selected, the corresponding setpoints of optical ring resonators may be determined from a look-up table (LUT) storing previously-acquired calibration data. For example, the controller 314 may determine the setpoints for a given target wavelength by accessing a LUT stored in the memory 315, and the controller 314 may cause the tuning elements of the ring resonators to adjust accordingly, based on those setpoints. Updating of the LUT may be achieved using a calibration method 1100 which will be described further with respect to FIG. 11.

Once a determination is made at 1008 that the final target wavelength has been reached, the total optical power over the spectrum may optionally be reported at 1010. For example, each optical power measurement acquired at a given target wavelength may be stored in a computer-readable medium, such that the set of measurements may be accessed via one or more computers.

The method 1000 may be repeated for multiple optical ports, either simultaneously or sequentially or both, depending on the OCM architecture. For example, the method 1000 may be performed sequentially for the ports 207 and 223, and/or the method 1000 may be performed simultaneously or concurrently for the ports 207 and 229.

FIG. 11 illustrates a method 1100 for calibrating a circuit configured for OCM in accordance with some examples of the proposed technology. The method 1100 may be used to calibrate the setpoints stored in the LUT, as described with respect to step 1008 in the method 1000. The method 1100 may be performed, for example, using the architecture 200 incorporated within the circuit 300. One or more steps of the method 1100 may be triggered by a controller of the circuit 300, such as the controller 314, based on computer-readable instructions stored on a computer-readable medium, such as the memory 315.

The method may begin with an optional step 1101 of selecting a reference light source to use for calibration. For example, this step may involve setting the on/off VOA of the fifth circuit 205 to “off”, or turning on the reference light source 225. This step may also involve setting the on/off VOAs in any first circuits (e.g., the first circuit 201, and the additional first circuit 211) to “on”, thereby fully attenuating the optical signals received at any optical ports (such as 207, 223, 229, 236).

At 1102, an optical signal received from the reference light source is split into a pair of single-polarization optical signals. For example, the fifth circuit 205 may split the optical signal 226 into two components, and may output the signal pair 227 and/or the signal pair 228. Where the optical signal output by the reference light source is a dual-polarization optical signal, the splitting may be achieved by a polarization rotator splitter such as 801 in combination with at least one 1×2 splitter such as 807 and/or 808. Where the optical signal output by the reference light source is a single-polarization optical signal, the splitting may be achieved by a 1×4 splitter such as 822.

At 1103, the pair of single-polarization optical signals are propagated through a respective pair of parallel paths, thereby resulting in a respective pair of filtered optical signals. Each path comprises N optical ring resonators in series, where N>1, and where each of the N optical ring resonators has (i) a setpoint selected for alignment with a target wavelength, and (ii) a different FSR from other FSRs of the N optical ring resonators in the path. The step 1103 corresponds to step 1004 of the method 1000, except that in the step 1103, the optical signals originate from a reference light source to be used for calibration, rather than an optical port to be measured.

At 1104, resonances of the N optical ring resonators in each path are aligned on the pair of optical signals using power maximization. Power maximization is described in more detail, for example, in United States Patent Application Publication No. 20230314310 to Ciena Corporation, and essentially uses certain spectral features of a reference signal to achieve alignment of the ring resonators. For example, the reference optical signal may have a peak (or local maximum) of optical power at a certain wavelength, and an attempt may be made to align on this the peak by maximizing a received photocurrent at the fourth circuit 700 (e.g., the electrical signal 707). The setpoints of the N optical ring resonators may be adjusted multiple times until the alignment is achieved.

At 1105, setpoints of the N optical ring resonators in each path are updated based on the aligning performed at 1104. Since the setpoints are not independent of each other, it may be sufficient to acquire only a single measurement or several measurements. The updated setpoints may be stored in a LUT which may be accessed during OCM measurements performed according to the method 1000.

By leveraging the advantages of integrated photonics, the technology described herein offers an attractive solution to OCM that is capable of faster scan times at higher resolutions and lower costs than conventional OCM techniques.

The scope of the claims should not be limited by the details set forth in the examples, but should be given the broadest interpretation consistent with the description as a whole.

What is claimed is:

1. A photonic integrated circuit (PIC) for optical channel monitoring comprising:
a first circuit configured to receive a first dual-polarization optical signal from a first optical port and to output a first pair of single-polarization optical signals;
a second circuit configured to receive the first pair of single-polarization optical signals and to output a first pair of attenuated optical signals attenuated by a respective first pair of variable attenuation amounts;
a third circuit configured to receive the first pair of attenuated optical signals and to output a respective first pair of filtered optical signals; and
a fourth circuit configured to receive the first pair of filtered optical signals and to output at least one analog electrical signal representing optical power of the first pair of filtered optical signals.

2. The PIC as claimed in claim 1, wherein the first circuit comprises
a first optical splitter configured to produce the first pair of single-polarization optical signals.

3. The PIC as claimed in claim 2, wherein the first circuit is further configured to receive a second dual-polarization optical signal from a second optical port, and wherein the first circuit further comprises
a second optical splitter configured to produce a second pair of single-polarization optical signals; and
a first pair of on/off variable optical attenuators (VOAs) configured to selectively attenuate, based on a selected optical port, one or both of (i) the first pair of single-polarization optical signals; and (ii) the second pair of single-polarization optical signals.

4. The PIC as claimed in claim 1, wherein the first circuit comprises a Mach-Zehnder architecture to selectively attenuate, based on a selected optical port, one or both of (i) the first pair of single-polarization optical signals; and (ii) the second pair of single-polarization optical signals.

5. The PIC as claimed in claim 1, wherein the second circuit comprises
a first pair of variable optical attenuators (VOAs) configured to attenuate respective optical powers of the first pair of single-polarization optical signals by the respective first pair of variable attenuation amounts.

6. The PIC as claimed in claim 5, wherein the second circuit further comprises
for each single-polarization optical signal, a first tap evanescent optical coupler (EOC) configured to couple a fraction of the single-polarization optical signal into a first tap waveguide for detection by a first photodiode; and
for each attenuated optical signal, a second tap EOC configured to couple a fraction of the attenuated optical signal into a second tap waveguide for detection by a second photodiode.

7. The PIC as claimed in claim 1, wherein the third circuit comprises a pair of parallel paths, each path comprising N optical ring resonators in series, wherein N>1, and wherein each of the N of optical ring resonators has (i) a setpoint selected for alignment with a target wavelength, and (ii) a different free spectral range (FSR) from other FSRs of the N of optical ring resonators in the path.

8. The PIC as claimed in claim 7, wherein 2≤N<6.

9. The PIC as claimed in claim 8, wherein N=3.

10. The PIC as claimed in claim 1, wherein the fourth circuit comprises
a dual-entry photodiode configured to detect the first pair of filtered optical signals.

11. The PIC as claimed in claim 1, further comprising
a fifth circuit configured to receive a reference optical signal from a reference optical port and to output a reference pair of single-polarization optical signals; and
a coupling circuit configured to couple the reference pair of single-polarization optical signals into the second circuit,
wherein the reference optical signal is generated by a reference light emitting diode (LED) or a reference LASER.

12. The PIC as claimed in claim 1, further comprising
an additional first circuit configured to receive a third dual-polarization optical signal from a third optical port and to output a third pair of single-polarization optical signals;
an additional second circuit configured to receive the third pair of single-polarization optical signals and to output a third pair of attenuated optical signals attenuated by a respective second pair of variable attenuation amounts;
an additional third circuit comprising an additional pair of parallel paths configured to receive the third pair of attenuated optical signals and to output a respective third pair of filtered optical signals, each path comprising M additional optical ring resonators in series, wherein M>1, and wherein each of the M of optical ring resonators has (i) a setpoint selected for alignment with the target wavelength, and (ii) a different FSR from other FSRs of the M of optical ring resonators in the path; and
an additional fourth circuit configured to receive the third pair of filtered optical signals and the second pair of variable attenuation amounts, and to calculate an optical power of the third dual-polarization optical signal.

13. A method for optical channel monitoring, the method comprising:
splitting a dual-polarization optical signal received from a selected optical port into a pair of single-polarization optical signals;
attenuating respective optical powers of the pair of single-polarization optical signals by a respective pair of variable attenuation amounts, thereby resulting in a pair of attenuated optical signals;
propagating the pair of attenuated optical signals through a respective pair of parallel paths, thereby resulting in a respective pair of filtered optical signals, each path comprising N optical ring resonators in series, wherein N>1, and wherein each of the N of optical ring resonators has (i) a setpoint selected for alignment with a target wavelength, and (ii) a different free spectral range (FSR) from other FSRs of the N of optical ring resonators; and
calculating an optical power of the dual-polarization optical signal at the target wavelength using the pair of filtered optical signals and the pair of variable attenuation amounts.

14. The method as claimed in claim 13, further comprising selecting the optical port for measurement from a plurality of optical ports.

15. The method as claimed in claim 13, the method further comprising
selecting a new value for the target wavelength; and
repeating the splitting, the attenuating, the propagating, and the calculating.

16. The method as claimed in claim 15, further comprising
reporting a total optical power of the dual-polarization optical signal over a spectrum.

17. The method as claimed in claim 13, wherein the attenuating is performed by a pair of variable optical attenuators (VOAs), the method further comprising
acquiring, at a first pair of tap evanescent optical couplers (EOCs), pre-VOA measurements of the optical powers of the pair of single-polarization optical signals;
acquiring, at a second pair of tap EOCs, post-VOA measurements of optical powers of the pair of attenuated optical signals; and
calculating the variable attenuation amounts using the pre-VOA measurements and the post-VOA measurements.

18. A method for calibrating an optical channel monitoring device, the method comprising:
splitting an optical signal received from a reference light source into a pair of single-polarization optical signals;
propagating the pair of single-polarization optical signals through a respective pair of parallel paths, thereby resulting in a respective pair of filtered optical signals, each path comprising N optical ring resonators in series, wherein N>1, and wherein each of the N optical ring resonators has (i) a setpoint selected for alignment with a target wavelength, and (ii) a different free spectral range (FSR) from other FSRs of the N optical ring resonators in the path;
aligning resonances of the N optical ring resonators on the pair of single-polarization optical signals using power maximization; and
updating the setpoints of the N optical ring resonators based on the aligning.

19. The method as claimed in claim 18, further comprising
coupling the single-polarization optical signals into the parallel paths using a pair of evanescent optical couplers (EOCs).

20. The method as claimed in claim 18, further comprising
attenuating the pair of single-polarization optical signals after the updating.
